(19) United States
(12) Patent Application Publication
(10) Pub. No.: US 2026/0204598 A1
(43) Pub. Date: Jul. 16, 2026

(54) FUEL CELL

(71) Applicant: SUBARU CORPORATION, Tokyo (JP)

(72) Inventor: Takumi NUNOKAWA, Tokyo (JP)

(21) Appl. No.: 19/429,279

(22) Filed: Dec. 22, 2025

(30) Foreign Application Priority Data
Jan. 10, 2025 (JP) 2025-004099

(51) Int. Cl. H01M 8/0276; H01M 8/0258; H01M 8/1004; H01M 8/248; H01M 8/10

(52) U.S. Cl. CPC H01M 8/0276; H01M 8/0258; H01M 8/1004; H01M 8/248; H01M 2008/1095

(57) ABSTRACT

A fuel cell at least includes a first separator, a first gasket, a sub-gasket, a membrane electrode assembly, a second separator, and a second gasket that are stacked together. One or each of the first separator and the second separator is a flow-channel separator. The fuel cell further includes a tension applier disposed outward with respect to an end portion of the first gasket and configured to apply a tension to the sub-gasket to press the sub-gasket against the first gasket in a region in which a surface pressure applied to the sub-gasket by the flow-channel separator is relatively low.

### CROSS-REFERENCE TO RELATED APPLICATIONS

The present application claims priority from Japanese Patent Application No. 2025-004099 filed on January 10, 2025, the entire contents of which are hereby incorporated by reference.

### BACKGROUND

The disclosure relates to a fuel cell.

Technologies for reducing the possibility of gas leakage from a fuel cell have been known.

For example, Japanese Unexamined Patent Application Publication (JP-A) No. 6-325777 describes a gas-sealing structure for a fuel cell including a fuel cell power generator, sheet-shaped gaskets, and outer pressers. The fuel cell power generator includes a solid polymer electrolyte membrane and gas diffusion electrodes disposed on both surfaces of the solid polymer electrolyte membrane. The sheet-shaped gaskets are disposed on both principal surfaces of the fuel cell power generator and are large enough to protrude from the edges of the fuel cell power generator. The outer pressers are disposed outside the sheet-shaped gaskets. The outer pressers cause the gaskets to be in close contact with the edges and end surfaces of the fuel cell power generator from the outside.

Japanese Unexamined Patent Application Publication (Translation of PCT Application) (JP-T) No. 2014-526788 describes a fuel cell assembly including a membrane electrode assembly, a cathode separator plate, a gasket, and a metal shim. The cathode separator plate has a series of corrugations extending, and provides air flow paths between first and second opposing edges of the plate. The gasket provides a fluid seal around a peripheral edge of the membrane electrode assembly between the separator plate and the membrane electrode assembly. The metal shim is disposed between the gasket and the separator plate over the peripheral edge of the membrane electrode assembly. The metal shim is provided as an integral part of the separator plate. The metal shim includes first and second strips longitudinally extending transverse the corrugations of the separator plate and extending along respective first and second opposing edges of the plate.

### SUMMARY

An aspect of the disclosure provides a fuel cell at least including a first separator, a first gasket, a sub-gasket, a membrane electrode assembly, a second separator, and a second gasket that are stacked together. One or each of the first separator and the second separator is a flow- channel separator. The fuel cell further includes a tension applier disposed outward with respect to an end portion of the first gasket and configured to apply a tension to the sub-gasket to press the sub-gasket against the first gasket in a region in which a surface pressure applied to the sub-gasket by the flow-channel separator is relatively low.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic diagram illustrating a vehicle including a fuel cell according to an embodiment of the disclosure;

FIG. 2 is an exploded perspective view illustrating the schematic configuration of the fuel cell according to the embodiment of the disclosure;

FIG. 3 is a plan view of a part of a fuel cell according to an embodiment of the disclosure;

FIG. 4 is a part of a sectional view of FIG. 3 taken along line IV-IV;

FIG. 5 is a part of a sectional view of FIG. 3 taken along line V-V, illustrating a case in which no tension is applied by a support;

FIG. 6 is a plan view of a part of the fuel cell according to the embodiment of the disclosure;

FIG. 7 is a plan view of a part of the fuel cell according to the embodiment of the disclosure;

FIG. 8 is a plan view of a part of a fuel cell according to an embodiment of the disclosure; and

FIG. 9 is a partial sectional perspective view along line IX-IX in FIG. 8.

### DETAILED DESCRIPTION

Gaskets such as those described in JP-A No. 6-325777 and JP-T No. 2014-526788 are typically used together with sub-gaskets to increase the sealing performance, and joined to the sub-gaskets with an adhesive. A sub-gasket typically has a flow-channel separator stacked on a side opposite to the side adjacent to a gasket. The flow-channel separator has a corrugated structure for defining gas flow channels and cooling-water flow channels.

The sub-gasket is typically a thin, low-adhesion member, and thus expands when a gas pressure is applied. In addition, since the flow-channel separator has the corrugated structure, the sub-gasket tends to receive non-uniform surface pressure from the flow-channel separator and to have regions in which the surface pressure is relatively low. Therefore, in a region in which the surface pressure is relatively low, a higher gas pressure may cause a separation of the sub-gasket from the gasket, leading to a gas leakage.

It is desirable to provide a technology for reducing the possibility of gas leakage by making the sub-gasket less likely to separate from the gasket in the regions in which the surface pressure applied to the sub-gasket by the flow-channel separator is relatively low.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. Overall Structure of Vehicle

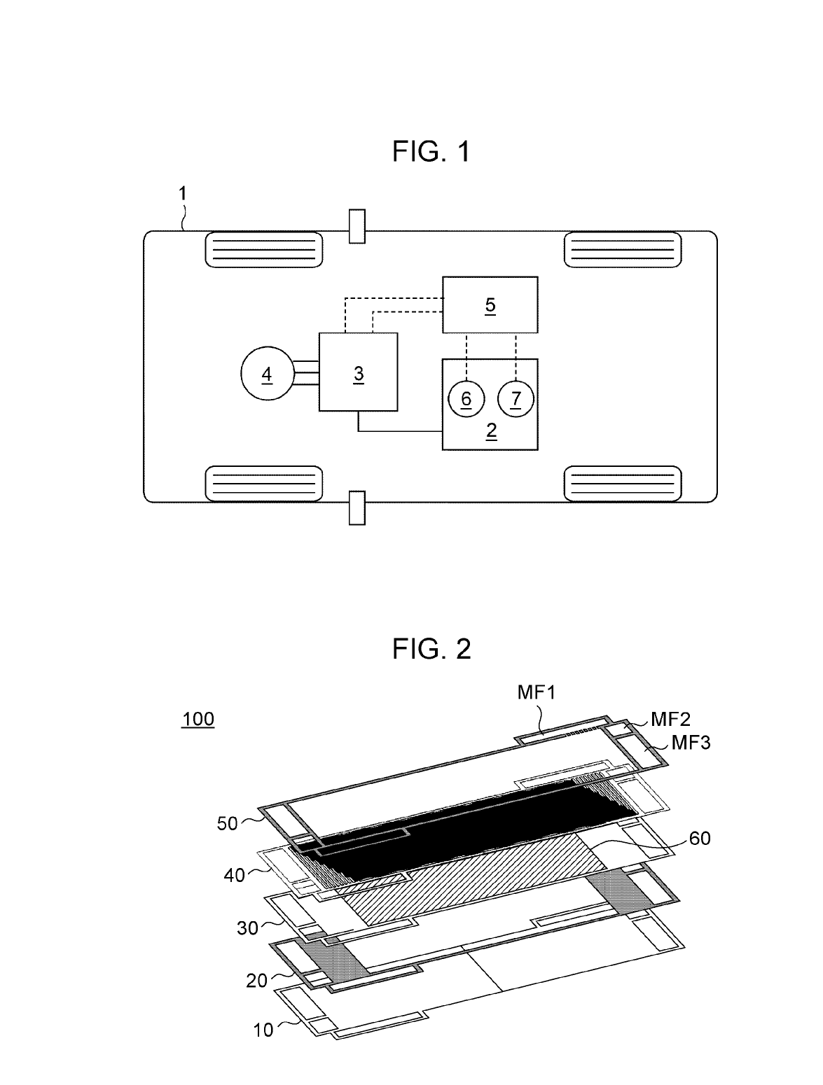

Referring to FIG. 1, a vehicle 1 according to the present embodiment at least includes a fuel cell stack 2, an inverter 3, a load 4, and a controller 5. In the vehicle 1, electric power generated by the fuel cell stack 2 is supplied to the load 4 through the inverter 3 under the control of the controller 5. The vehicle 1 includes, for example, known components (not illustrated) of a fuel cell vehicle, such as a hydrogen tank, an anode gas supplier, a cathode gas supplier, a coolant supplier, and a DC/DC converter.

The fuel cell stack 2 includes tens to hundreds of fuel cells 100 described below stacked in a stacking direction. Each fuel cell 100 serves to generate electricity by causing anode gas and cathode gas to react. The fuel cell stack 2 may include a known voltage sensor 6 capable of measuring, for example, a voltage applied to each fuel cell 100. The fuel cell stack 2 may also include a known current sensor 7 capable of measuring a current that flows through each fuel cell 100. There is no particular limitation regarding the fuel cells 100, and the fuel cells 100 may be, for example, known polymer electrolyte fuel cells (PEFCs).

The inverter 3 has a function of converting direct- current power boosted by, for example, a DC/DC converter into alternating-current power suitable for driving the load 4. There is no particular limitation regarding the inverter 3 as long as the above-described function is provided. For example, a known inverter including a three-phase bridge circuit may be used.

The load 4 includes, for example, a known electric motor capable of outputting power for driving drive wheels of the vehicle 1. The electric motor is, for example, a known three-phase alternating-current electric motor. The load 4 may be another electric device mounted in the vehicle 1.

The controller 5 is a known electronic control unit (ECU) mounted in a fuel cell vehicle and includes one or more processors, such as central processing units (CPUs), and one or more memories, such as semiconductor memories, magnetic memories, or optical memories, communicatively coupled to the processors. The controller 5 may further include a known battery management unit (BMU) that monitors and controls the state of a battery. The controller 5 may be capable of communicating with another known ECU and various sensors (not illustrated) mounted in the vehicle 1.

### 2. Overall Structure of Fuel Cell

The overall structure of the fuel cell 100 that may be included in the fuel cell stack 2 installed in the vehicle 1 will be briefly described with reference to FIG. 2. The fuel cell 100 is, for example, formed by stacking a flat separator 10, a first gasket 20, a sub-gasket 30, a flow-channel separator 40, and a second gasket 50 in that order. The fuel cell 100 further includes a membrane electrode assembly 60 disposed between the flat separator 10 and the flow-channel separator 40. The flat separator 10 is an example of a "first separator" according to an embodiment of the disclosure. The flow-channel separator 40 is an example of a "second separator" according to an embodiment of the disclosure. The combination of the first gasket 20 and the second gasket 50 may be a combination of a cathode gasket and a cooling-water gasket or a combination of an anode gasket and a cooling-water gasket.

### 2-1. Flat Separator

The flat separator 10 is a rectangular, flat separator. One of anode gas and cathode gas flows along a surface of the flat separator 10 that faces the membrane electrode assembly 60. The flat separator 10 has cooling-water-manifold through holes MF1 and gas-manifold through holes MF2 and MF3. For example, the cooling-water-manifold through holes MF1 in the flat separator 10 are formed in portions on the long sides of the flat separator 10. The gas-manifold through holes MF2 and MF3 in the flat separator 10 are formed in portions on the short sides of the flat separator 10.

The flat separator 10 may be, for example, a known metal separator made of aluminum or stainless steel, or a known carbon separator made of a carbon-based material, but is not particularly limited to these examples.

### 2-2. First Gasket

The first gasket 20 has an outer shape corresponding to that of the flat separator 10. The first gasket 20 has cooling-water-manifold through holes MF1 and gas-manifold through holes MF2 and MF3 corresponding to those in the flat separator 10. For example, the cooling-water-manifold through holes MF1 in the first gasket 20 are formed in portions on the long sides of the first gasket 20 so as to correspond to those in the flat separator 10. The gas-manifold through holes MF2 and MF3 in the first gasket 20 are formed in portions on the short sides of the first gasket 20 so as to correspond to those in the flat separator 10.

The first gasket 20 may be made of a sealing material, for example, a synthetic resin, such as polyethylene naphthalate (PEN), polyethylene terephthalate (PET), polyphenylene sulfide (PPS), silicone rubber, ethylene propylene rubber, or fluorine rubber, but is not particularly limited to these examples.

### 2-3. Sub-gasket

The sub-gasket 30 has an outer shape corresponding to those of the flat separator 10 and the first gasket 20. The sub-gasket 30 has cooling-water-manifold through holes MF1 and gas-manifold through holes MF2 and MF3 corresponding to those in the flat separator 10 and the first gasket 20. For example, the cooling-water-manifold through holes MF1 in the sub-gasket 30 are formed in portions on the long sides of the sub-gasket 30 so as to correspond to those in the flat separator 10 and the first gasket 20. The gas-manifold through holes MF2 and MF3 in the sub-gasket 30 are formed in portions on the short sides of the sub-gasket 30 so as to correspond to those in the flat separator 10 and the first gasket 20. In the example illustrated in FIG. 2, the gas-manifold through holes MF2 and MF3 are disposed next to each other along each short side of the sub-gasket 30. The sub-gasket 30 has an accommodation space in which the membrane electrode assembly 60 is disposed in a central area.

The sub-gasket 30 may be made of a sealing material, for example, a synthetic resin, such as polyethylene naphthalate (PEN), polyethylene terephthalate (PET), or polyphenylene sulfide (PPS), but is not particularly limited to these examples.

### 2-4. Flow-Channel Separator

The flow-channel separator 40 at least has a corrugated structure for defining gas flow channels and cooling-water flow channels. The other of the anode gas and the cathode gas flows along the side of the flow-channel separator 40 facing the membrane electrode assembly 60, and the cooling water flows along the side of the flow-channel separator 40 opposite to the side facing the membrane electrode assembly 60.

The flow-channel separator 40 has cooling-water-manifold through holes MF1 and gas-manifold through holes MF2 and MF3 corresponding to those in the flat separator 10, the first gasket 20, and the sub-gasket 30. For example, the cooling-water-manifold through holes MF1 in the flow-channel separator 40 are formed in portions on the long sides of the flow-channel separator 40 so as to correspond to those in the flat separator 10, the first gasket 20, and the sub-gasket 30. The gas-manifold through holes MF2 and MF3 in the flow-channel separator 40 are formed in portions on the short sides of the flow-channel separator 40 so as to correspond to those in the flat separator 10, the first gasket 20, and the sub-gasket 30.

The flow-channel separator 40 may be, for example, a known metal separator made of aluminum or stainless steel, or a known carbon separator made of a carbon-based material. However, the flow-channel separator 40 is not particularly limited to these examples.

### 2-5. Second Gasket

The second gasket 50 has an outer shape corresponding to those of the flat separator 10, the first gasket 20, the sub-gasket 30, and the flow-channel separator 40. The second gasket 50 has cooling-water-manifold through holes MF1 and gas-manifold through holes MF2 and MF3 corresponding to those in the flat separator 10, the first gasket 20, the sub-gasket 30, and the flow-channel separator 40. For example, the cooling-water-manifold through holes MF1 in the second gasket 50 are formed in portions on the long sides of the second gasket 50 so as to correspond to those in the flat separator 10, the first gasket 20, the sub-gasket 30, and the flow-channel separator 40. The gas-manifold through holes MF2 and MF3 in the second gasket 50 are formed in portions on the short sides of the second gasket 50 so as to correspond to those in the flat separator 10, the first gasket 20, the sub-gasket 30, and the flow-channel separator 40.

The second gasket 50 may be made of a sealing material, for example, a synthetic resin, such as polyethylene naphthalate (PEN), polyethylene terephthalate (PET), polyphenylene sulfide (PPS), silicone rubber, ethylene propylene rubber, or fluorine rubber, but is not particularly limited to these examples.

### 2-6. Membrane Electrode Assembly

As described above, the membrane electrode assembly 60 is placed in the accommodation space formed in the sub-gasket 30. The membrane electrode assembly 60 may be a known or any other membrane electrode assembly in which an electrolyte layer (not illustrated) is disposed between a pair of catalyst layers (not illustrated) and a pair of gas diffusion layers (not illustrated).

The overall structure of the fuel cell 100 that may be installed in the vehicle 1 according to an embodiment of the disclosure has been briefly described. However, the fuel cell 100 according to the embodiment of the disclosure is not limited to this, and may further include, for example, a known or any other gasket in addition to the first gasket 20 and the second gasket 50.

### 3. First Embodiment

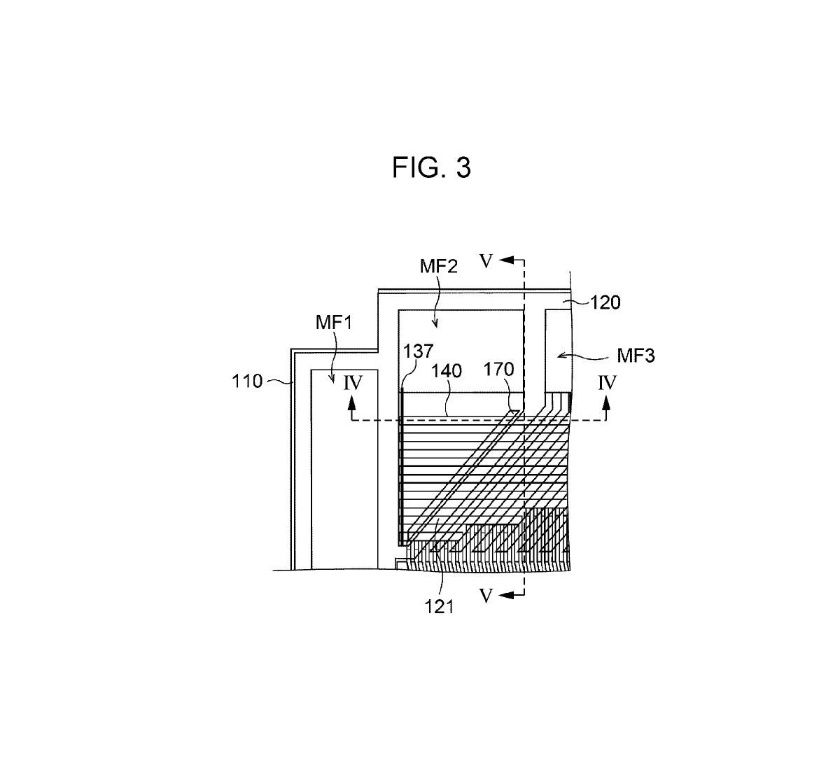

In an embodiment of the disclosure, a tension applier is disposed outward with respect to an end portion of the first gasket 20 and configured to apply a tension to the sub-gasket 30 illustrated in FIG. 2 to press the sub-gasket 30 against the first gasket 20 in a region in which the surface pressure applied by the flow-channel separator 40 is relatively low. Referring also to FIGS. 3 to 7, a tension applier according to a first embodiment will be described in detail by way of an example in which a flat separator 110, a first gasket 120, a sub-gasket 130, and a flow-channel separator 140 can serve as the flat separator 10, the first gasket 20, the sub-gasket 30, and the flow-channel separator 40 illustrated in FIG. 2.

### 3-1. Protruding Portion

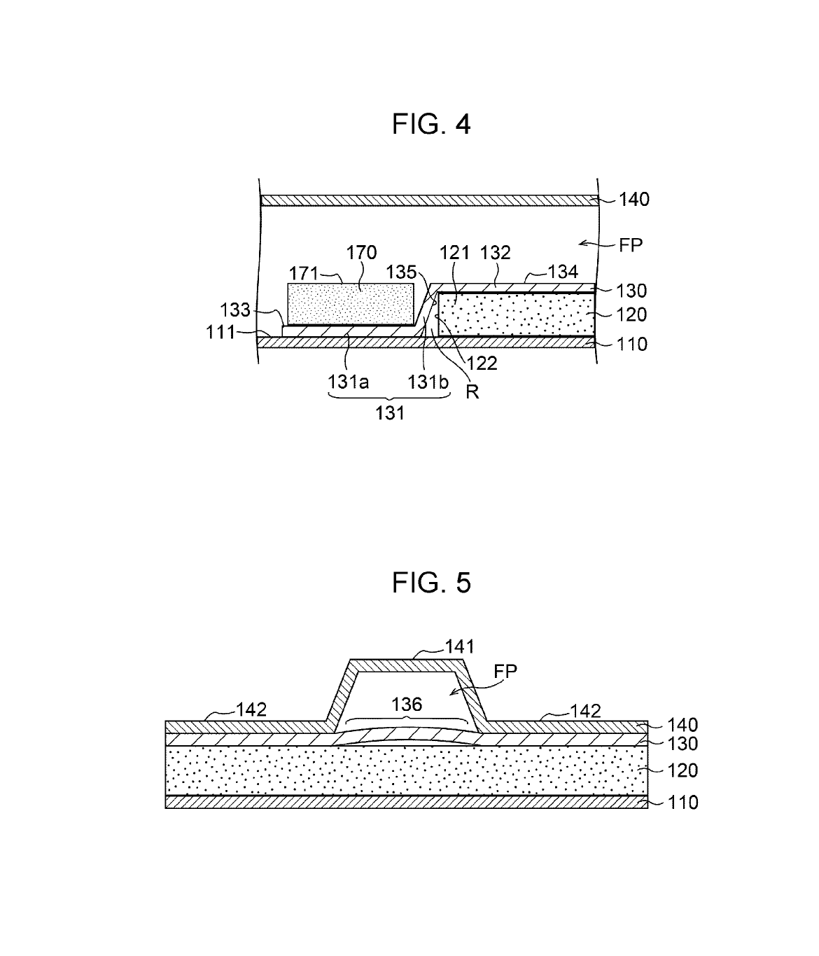

Referring to FIGS. 3 and 4, the sub-gasket 130 includes a protruding portion 131 that extends outward beyond an end portion 121 of the first gasket 120. Here, "outward" means toward the side of the first gasket 120 or away from the central region of the cell in the first gasket 120 in the example illustrated in FIG. 3.

For example, the protruding portion 131 may include a flat portion 131a and an inclined portion 131b. The flat portion 131a is retained in contact with a principal surface 111 of the flat separator 110 by a support 170 described below. The inclined portion 131b extends continuously from the flat portion 131a and is coupled to a main body 132 of the sub-gasket 130. In FIG. 4, which is a sectional view taken along line IV-IV, the sub-gasket 130 may have a step formed by the flat portion 131a, the inclined portion 131b, and the main body 132 and having a dimension corresponding to the thickness of the first gasket 120.

The shapes of the flat portion 131a, the inclined portion 131b, and the main body 132 are not particularly limited as long as a tension can be applied by the support 170 described below, and may be determined as appropriate in accordance with the shapes of the first gasket 120 and other components. The protruding portion 131 may be permanently affixed to the sub-gasket 130 when the sub-gasket 130 is formed by a known or any other method.

### 3-2. Support

Referring to FIG. 4, the support 170, which corresponds to a tension applier according to the first embodiment, is disposed on a principal surface 133, which is one of the principal surfaces of the protruding portion 131 at a side opposite to the side adjacent to the first gasket 120. The technical significance of the support 170 will now be described.

Referring to FIG. 5, the flow-channel separator 140 has a corrugated structure in which a ridge portion 141 and a groove portion 142 are alternately arranged to form a repeating pattern. A gas flow channel FP is formed in a section surrounded by the ridge portion 141 and the sub-gasket 130. The surface pressure applied to the sub-gasket 130 by the flow-channel separator 140 is lower in a region 136 in which the sub-gasket 130 is in contact with the gas flow channel FP than in a region in which the sub-gasket 130 is in contact with the groove portion 142. Therefore, when the support 170 is not provided, a higher gas pressure may cause a separation of the sub-gasket 130 from the first gasket 120 in the region 136 in which the surface pressure applied by the flow-channel separator 140 is relatively low (hereinafter sometimes referred to simply as a "low-surface-pressure region").

In contrast, when the support 170 is provided, the sub-gasket 130 receives a tension in a direction from the main body 132 toward the protruding portion 131 of the sub-gasket 130. This tension creates a pressing force that presses the sub-gasket 130 against the first gasket 120 in the low-surface-pressure region 136, thereby increasing a joining force between the first gasket 120 and the sub-gasket 130. Accordingly, the sub-gasket 130 is less likely to separate from the first gasket 120, so that the possibility of gas leakage can be reduced.

According to the first embodiment, no member for directly pressing the sub-gasket 130 in the low-surface-pressure region 136 from the gas flow channel FP is disposed in the gas flow channel FP. Therefore, the gas flow channel FP allows gas to smoothly flow therethrough.

In one example, the support 170 may be disposed outward with respect to the end portion 121 of the first gasket 120 so as to extend in a direction in which the end portion 121 extends. In the example illustrated in FIG. 3, the end portion 121 of the first gasket 120 is a sealing wall that separates gas flowing from the gas-manifold through hole MF2 and gas flowing from the gas-manifold through hole MF3 from each other. The end portion 121 is inclined relative to the long and short sides of the first gasket 120, and couples the long and short sides to each other. In FIG. 4, which is a sectional view taken along line IV-IV, the support 170 may have a rectangular cross section that can be in contact with the flat portion 131a of the protruding portion 131. However, the cross-sectional shape of the support 170 is not limited to a rectangular shape as long as the above-described tension can be applied. In addition, the height of a principal surface 171 of the support 170 at a side opposite to the side adjacent to the flat portion 131a of the sub-gasket 130 may be the same or substantially the same as the height of a principal surface 134 of the main body 132 of the sub-gasket 130 at a side opposite to the side adjacent to the first gasket 120.

The material of the support 170 may be, for example, a sealing material similar to the material of the first gasket 120. However, the material of the support 170 is not particularly limited as long as the above-described tension can be applied. The support 170 may be fixed to the principal surface 133 of the protruding portion 131 by a known or any other adhesive.

### 3-3. Gasket material

Referring to FIG. 4, a region R surrounded by the flat separator 110, the first gasket 120, and the sub-gasket 130 may be filled with a gasket material. The gasket material that fills the region R reduces the possibility of gas leakage even when the sub-gasket 130 is separated from the first gasket 120 in the low-surface-pressure region 136 of the sub-gasket 130, as illustrated in FIG. 5. When the region R is filled with the gasket material, the above-described pressing force is also applied to the gasket material, and thus the pressing force applied to the sub-gasket 130 may be weaker than when no gasket material is provided. However, this does not pose any particular problem in achieving the effects of the embodiment of the disclosure.

In one example, the gasket material may be provided to fill the region R surrounded by the principal surface 111 of the flat separator 110 that is adjacent to the first gasket 120, an end surface 122 of the first gasket 120, and a principal surface 135 of the inclined portion 131b of the sub-gasket 130 at a side opposite to the side adjacent to the support 170. The region R may be filled with the gasket material by a known or any other method when the first gasket 120 and the sub-gasket 130 are formed on the flat separator 110.

The material of the gasket material may be a known or any other liquid gasket, but may also be, for example, a rubber material or the like formed in a shape corresponding to the shape of the region R in advance as long as the possibility of gas leakage can be reduced as described above.

### 3-4. Reliever

Referring to FIG. 3, the sub-gasket 130 may receive an excessive stress in an in-plane direction depending on the position of the support 170. In such a case, there is a possibility that the sub-gasket 130 may accidentally break. To reduce such a possibility, the sub-gasket 130 may further include a reliever 137 configured to relieve the stress applied to the sub-gasket 130 in an in-plane direction at a position outward with respect to the support 170, which corresponds to a tension applier.

For example, the reliever 137 may be a discontinuous or continuous cut formed in a portion of the surface of the sub-gasket 130 by a known or any other method at any position at which the sub-gasket 130 does not contribute to sealing of the gas. In the example illustrated in FIG. 3, the sub-gasket 130 has an outer shape similar to that of the flat separator 110, and a cut corresponding to the reliever 137 extends along a long side of the sub-gasket 130 at a position near the boundary between the sub-gasket 130 and a long side of the first gasket 120. The shape of the cut corresponding to the reliever 137 is not particularly limited as long as the stress applied to the sub-gasket 130 in an in-plane direction can be relieved.

### 3-5. Reinforcement

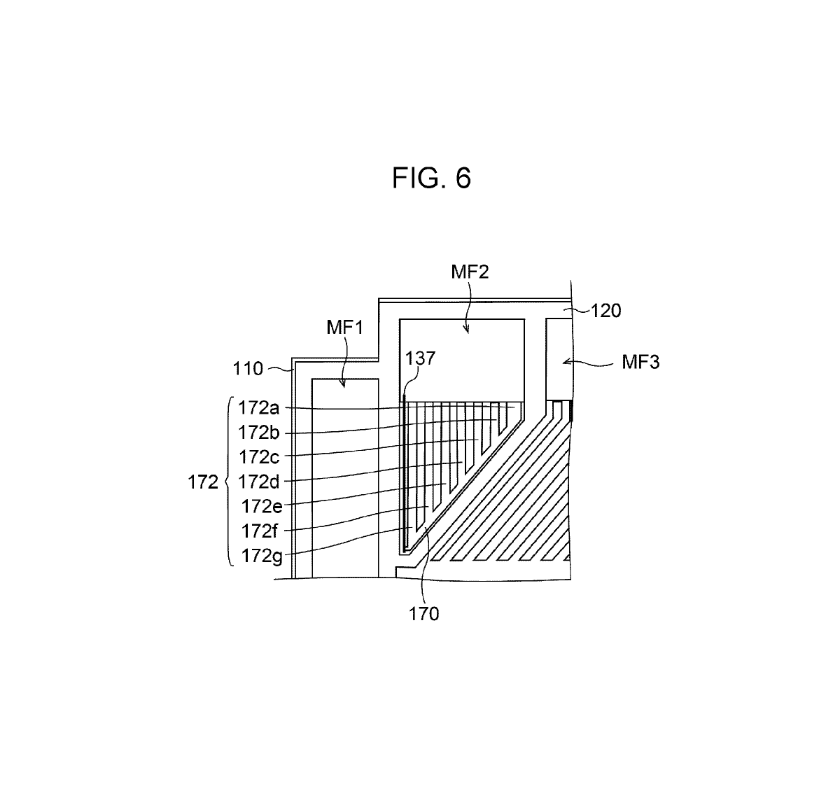

Referring to FIG. 6, the tension applier may include, in addition to the above-described support 170, a reinforcement 172 that extends from the support 170 toward a short side of the first gasket 120 along the short side of the first gasket 120. In FIG. 6, the flow-channel separator 140 is not illustrated. In one example, the reinforcement 172 may include ribs 172a, 172b, 172c, 172d, 172e, 172f, and 172g. The ribs 172a to 172g may be separated from each other at predetermined intervals along the short side of the first gasket 120, and may extend along the long side of the first gasket 120 from the support 170 to the short side of the first gasket 120 (for example, to a position in front of or inside the gas-manifold through hole MF2). The thickness of the ribs 172a to 172g is determined so that the height of principal surfaces of the ribs 172a to 172g at a side opposite to the side adjacent to the flat separator 110 is the same or substantially the same as the height of the principal surface 134 of the main body 132 of the sub-gasket 130 at a side opposite to the side adjacent to the first gasket 120.

The reinforcement 172 enables the second gasket 50, illustrated in FIG. 2, to receive a uniform or substantially uniform surface pressure. Additionally, the support 170 and the reinforcement 172 are integrated together, so that the size of the tension applier is increased to facilitate handling.

### 3-6. Others

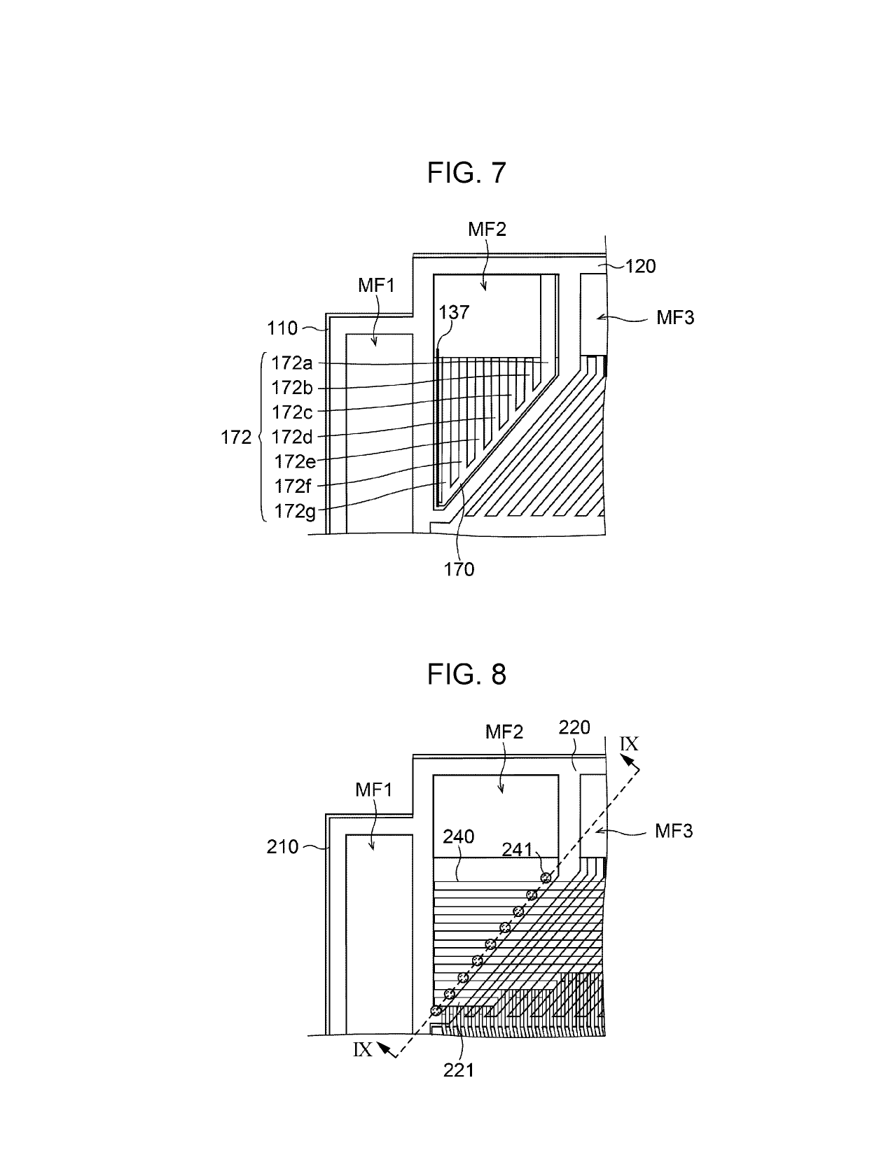

Referring to FIG. 7, the above-described support 170 and the first gasket 120 may be permanently affixed to each other. In FIG. 7, the flow-channel separator 140 is not illustrated as in FIG. 6. In one example, at least one of the ribs 172a to 172g (for example, the rib 172a) may extend along the long side of the first gasket 120 beyond the gas-manifold through hole MF2 so that the support 170 and the first gasket 120 are permanently affixed. In such a case, transportation of the component and positioning of the support 170 can be facilitated.

### 3-7. Summary

As described above, the fuel cell 100 according to the first embodiment includes the support 170, which corresponds to the tension applier. The support 170 is disposed outward with respect to the end portion 121 of the first gasket 120. In one example, the sub-gasket 130 includes the protruding portion 131 that extends outward beyond the end portion 121 of the first gasket 120. The support 170 is disposed on the principal surface 133, which is one of the principal surfaces of the protruding portion 131 at a side opposite to the side adjacent to the first gasket 120.

According to the above-described structure, the sub- gasket 130 receives a tension for pressing the sub-gasket 130 against the first gasket 120 in the low-surface-pressure region 136. In other words, the sub-gasket 130 receives a tension in a direction from the main body 132 toward the protruding portion 131 of the sub-gasket 130. This tension creates a pressing force that presses the sub-gasket 130 against the first gasket 120 in the low-surface-pressure region 136, thereby increasing the joining force between the first gasket 120 and the sub-gasket 130. Accordingly, the sub-gasket 130 is less likely to separate from the first gasket 120 in the low-surface-pressure region 136 of the sub-gasket 130, so that the possibility of gas leakage can be reduced.

### 4. Second Embodiment

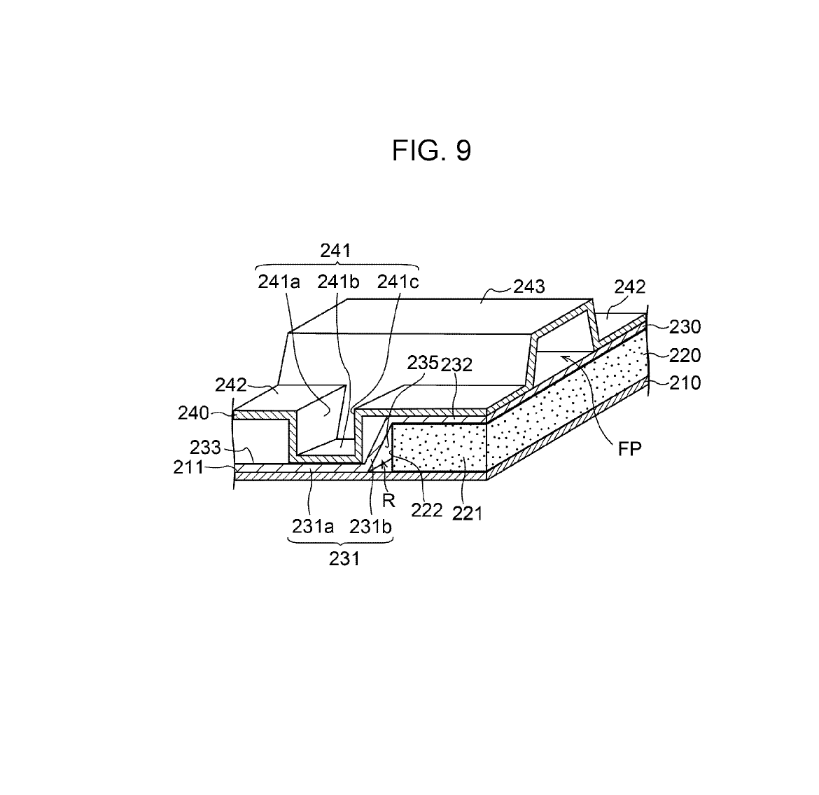

Referring to FIGS. 8 and 9, a tension applier according to a second embodiment will be described in detail by way of an example in which a flat separator 210, a first gasket 220, a sub-gasket 230, and a flow-channel separator 240 can serve as the flat separator 10, the first gasket 20, the sub-gasket 30, and the flow-channel separator 40 illustrated in FIG. 2.

### 4-1. Protruding Portion

The sub-gasket 230 includes a protruding portion 231 that extends outward beyond an end portion 221 of the first gasket 220. The protruding portion 231 may include a flat portion 231a and an inclined portion 231b, which may be structured similarly to those of the protruding portion 131 according to the first embodiment. For details, refer to the description of the first embodiment.

### 4-2. Projection

The flow-channel separator 240 includes a projection 241 as the tension applier. The projection 241 projects toward the protruding portion 231 and is in contact with the protruding portion 231. The technical significance of the flow-channel separator 240 including the projection 241 will now be described.

When the flow-channel separator 240 does not include the projection 241, for a reason similar to that described in the first embodiment, a higher gas pressure may cause a separation of the sub-gasket 230 from the first gasket 220 in the low-surface-pressure regions in which the surface pressure applied by the flow-channel separator 240 is relatively low. In contrast, when the flow-channel separator 240 includes the projection 241, the sub-gasket 230 receives a tension in a direction from a main body 232 toward the protruding portion 231 of the sub-gasket 230. This tension creates a pressing force that presses the sub-gasket 230 against the first gasket 220 in the low-surface-pressure regions, thereby increasing a joining force between the first gasket 220 and the sub-gasket 230. Accordingly, the sub-gasket 230 is less likely to separate from the first gasket 220, so that the possibility of gas leakage can be reduced.

In one example, in the plan view of FIG. 8, multiple projections 241 may be disposed outward with respect to the end portion 221 of the first gasket 220 and aligned at intervals therebetween along a direction in which the end portion 221 extends (for example, the direction along line IX-IX). In the example illustrated in FIG. 8, the end portion 221 of the first gasket 220 is a sealing wall that separates gas flowing from the gas-manifold through hole MF2 and gas flowing from the gas-manifold through hole MF3 from each other. The end portion 221 is inclined relative to the long and short sides of the first gasket 220, and couples the long and short sides to each other.

Referring to FIG. 9, in one example, the flow-channel separator 240 has a corrugated structure in which a groove portion 242, which is in contact with the sub-gasket 230, and a ridge portion 243, which is in contact with a flat separator 210 that is not illustrated, are alternately arranged. A gas flow channel FP is formed in a region surrounded by the ridge portion 243 and the sub-gasket 230, and a cooling-water flow channel is formed on the groove portion 242 at a side opposite to the side adjacent to the sub-gasket 230. The groove portion 242 partially projects toward the protruding portion 231 at a position outward with respect to the end portion 221 of the first gasket 220, forming the projection 241 in contact with the flat portion 231a. In the example illustrated in FIG. 9, the projection 241 includes a first side wall 241a extending in the direction along line IX-IX, a contact portion 241b connected with the first side wall 241a and in contact with the flat portion 231a, and a second side wall 241c connected with the contact portion 241b and extending in the direction along line IX-IX. The projection 241 has a rectangular cross section in a plane crossing line IX-IX.

The projection 241 may be formed as appropriate when the flow-channel separator 240 is formed by, for example, a known or any other pressing process. In the example illustrated in FIG. 9, the projection 241 has a hollow structure partially surrounded by the first side wall 241a, the contact portion 241b, and the second side wall 241c. However, the embodiment of the disclosure is not limited to this, and the projection 241 may have a solid structure or be structured such that the groove portion 242 is flat as long as the projection 241 is in contact with the protruding portion 231.

### 4-3. Gasket Material

A region R surrounded by the flat separator 210, the first gasket 220, and the sub-gasket 230 may be filled with a gasket material. In one example, the gasket material may be provided to fill the region R surrounded by a principal surface 211 of the flat separator 210 that is adjacent to the first gasket 220, an end surface 222 of the first gasket 220, and a principal surface 235 of the inclined portion 231b of the sub-gasket 230 at a side opposite to the side adjacent to the projection 241. The material of the gasket material is similar to that in the first embodiment, and the description in the first embodiment applies.

### 4-4. Reliever

The sub-gasket 230 may include a reliever (not illustrated) configured to relieve the stress applied to the sub-gasket 230 in an in-plane direction at a position outward with respect to the projection 241, which corresponds to a tension applier. The sub-gasket 230 may have a structure similar to that of the reliever 137 according to the first embodiment.

### 4-5. Summary

As described above, the fuel cell 100 according to the second embodiment includes the projection 241, which corresponds to the tension applier. The projection 241 is disposed outward with respect to the end portion 221 of the first gasket 220. In one example, the sub-gasket 230 includes the protruding portion 231 that extends outward beyond the end portion 221 of the first gasket 220. The flow-channel separator 240 includes the projection 241 as the tension applier. The projection 241 projects toward the protruding portion 231 and is in contact with the protruding portion 231.

According to the above-described structure, the sub-gasket 230 receives a tension for pressing the sub-gasket 230 against the first gasket 220 in the low-surface-pressure regions in which the surface pressure applied by the flow-channel separator 240 is relatively low. In other words, the sub-gasket 230 receives a tension in a direction from the main body 232 toward the protruding portion 231 of the sub-gasket 230. This tension creates a pressing force that presses the sub-gasket 230 against the first gasket 220 in the low-surface-pressure regions, thereby increasing the joining force between the first gasket 220 and the sub-gasket 230. Accordingly, the sub-gasket 230 is less likely to separate from the first gasket 220 in the low-surface-pressure regions of the sub-gasket 230, so that the possibility of gas leakage can be reduced.

In addition, according to the second embodiment, the projection 241 that serves as the tension applier and the flow-channel separator 240 are permanently affixed. Thus, the tension applier can be more easily positioned relative to the sub-gasket 230 than in the first embodiment, and the yield of the fuel cell 100 can be increased. Additionally, the number of components of the fuel cell 100 can be reduced.

Although embodiments of the disclosure have been described in detail above with reference to the drawings, the disclosure is not limited to these examples. It is obvious that a person having ordinary knowledge in the technical field to which the disclosure pertains can arrive at various alterations and modifications within the scope of the technical idea described in the claims, and it is to be understood that such alterations and modifications also belong to the technical scope of the disclosure. For example, functions or the like included in components, steps, or the like may be rearranged without any logical inconsistencies, and the components, steps, or the like may be combined together or divided.

The technology of the embodiments of the disclosure may be implemented as a vehicle 1 including the fuel cell 100 according to the above-described embodiments.

According to the embodiments of the disclosure, the sub-gasket is less likely to separate from the gasket in the regions in which the surface pressure applied to the sub-gasket by the flow-channel separator is relatively low, so that the possibility of gas leakage can be reduced.

1. A fuel cell at least comprising:
a first separator, a first gasket, a sub-gasket, a membrane electrode assembly, a second separator, and a second gasket that are stacked together,
wherein one or each of the first separator and the second separator is a flow-channel separator, and
wherein the fuel cell further comprises a tension applier disposed outward with respect to an end portion of the first gasket and configured to apply a tension to the sub-gasket to press the sub-gasket against the first gasket in a region in which a surface pressure applied to the sub-gasket by the flow-channel separator is relatively low.

2. The fuel cell according to claim 1,
wherein the sub-gasket comprises a protruding portion that extends outward beyond the end portion of the first gasket, and
wherein the tension applier is disposed on a principal surface of the protruding portion at a side opposite to a side adjacent to the first gasket.

3. The fuel cell according to claim 1,
wherein the sub-gasket comprises a protruding portion that extends outward beyond the end portion of the first gasket, and
wherein the flow-channel separator comprises a projection as the tension applier, the projection projecting toward the protruding portion and being in contact with the protruding portion.

4. The fuel cell according to claim 1,
wherein a region surrounded by the first separator, the first gasket, and the sub-gasket is filled with a gasket material.

5. The fuel cell according to claim 2,
wherein a region surrounded by the first separator, the first gasket, and the sub-gasket is filled with a gasket material.

6. The fuel cell according to claim 3,
wherein a region surrounded by the first separator, the first gasket, and the sub-gasket is filled with a gasket material.

7. The fuel cell according to claim 1,
wherein the sub-gasket comprises a reliever configured to relieve stress applied to the sub-gasket in an in-plane direction at a position outward with respect to the tension applier.

8. The fuel cell according to claim 2,
wherein the sub-gasket comprises a reliever configured to relieve stress applied to the sub-gasket in an in-plane direction at a position outward with respect to the tension applier.

9. The fuel cell according to claim 3,
wherein the sub-gasket comprises a reliever configured to relieve stress applied to the sub-gasket in an in-plane direction at a position outward with respect to the tension applier.
